(19) United States
(12) Patent Application Publication
(10) Pub. No.: US 2013/0333281 A1
(43) Pub. Date: Dec. 19, 2013

(54) APPARATUS AND SYSTEM FOR GROWING PLANTS

(71) Applicant: Efraim Donitz, North Hollywood, CA (US)

(72) Inventor: Efraim Donitz, North Hollywood, CA (US)

(73) Assignee: EFCO INC., North Hollywood, CA (US)

(21) Appl. No.: 13/918,686

(22) Filed: Jun. 14, 2013

Related U.S. Application Data
(60) Provisional application No. 61/660,775, filed on Jun. 17, 2012.

(51) Int. Cl. A01G 9/12; A01G 13/02

(52) U.S. Cl. CPC A01G 9/12; A01G 13/02
USPC 47/29.5; 47/39; 47/65.5; 47/79; 211/74

(57) ABSTRACT

An apparatus and system for growing plants having a garden structure comprised of a plurality of interconnected trellis panel frames made of frame segments which are connected together by fittings, with attached soil containers for growing plants.

This application claims the benefit of priority to U.S. provisional patent application 61/660,775 filed on Jun. 17, 2012, the contents of which are hereby incorporated by reference.

### BACKGROUND OF THE INVENTION

The present invention is an apparatus and system for growing plants in a limited space during all seasons creating its own ecological environment, and is ideal for growing organic vegetables and herbs.

### BRIEF SUMMARY OF THE INVENTION

The apparatus and system of the present invention consists of multiple trellis panel frames which are connected together by fittings to form a single garden structure with attached soil containers for growing plants. In a preferred embodiment there are three triangular trellis panels joined together to form a garden structure in the shape of a pyramid, with the attached soil containers arranged vertically into at least two levels.

The garden structure may also have its own efficient irrigation system which in a preferred embodiment is contemplated to be a ring of pipe having at least one dripper located within a pyramid the garden structure at a location above the soil containers. Each upper level soil container is also contemplated to have at least one drainage hole in so as to facilitate the drainage of excess water into a soil container located beneath the upper level soil container. The lowest level soil containers may also drain into a dish and this drainage is returned to the upper level soil containers (e.g. via a pumping mechanism) in an attempt to preserve nutrients for the plants.

The pyramid garden structure in a preferred embodiment also has a plurality of outward extending cover arms that function to support a cover for the garden structure. The cover may be made of cloth for providing shade, and protecting the garden plants from birds or insects. It is contemplated that a cover will be an appropriate plastic 2 mm-4 mm thick so as to function as a greenhouse for the plants in the garden structure.

The apparatus and system described herein is a growing system for all seasons, which may be easily constructed and used for either indoor or outdoor use. It is contemplated that the apparatus and system described herein will be particularly useful for creating gardens in environments with a limited amount of space, such as for example apartments. Further details on the construction and use of the inventive plant growing apparatus and system are set forth below.

### BRIEF DESCRIPTION OF THE SEVERAL VIEWS OF THE DRAWINGS

FIG. 1 is a perspective view of the pyramid garden system.

FIG. 2 is a front side view of the pyramid garden system.

FIG. 3 is a back side view of the pyramid garden system.

FIG. 4 is a left side view of the pyramid garden system.

FIG. 5 is a right side view of the pyramid garden system.

FIG. 6 is a top side view of the pyramid garden system.

FIG. 7 is a bottom side view of the pyramid garden system.

FIG. 8 is a top view of a top frame fitting.

FIG. 9 is a front view of a top frame fitting.

FIG. 10 is a right side view of a top frame fitting.

FIG. 11 is a top view of a left center frame fitting.

FIG. 12 is a front perspective view of a left center frame fitting.

FIG. 13 is a right side perspective view of a left center frame fitting.

FIG. 14 is a front view of a right center frame fitting.

FIG. 15 is a bottom view of a right center frame fitting.

FIG. 16 is a front perspective view of a right center frame fitting.

FIG. 17 is a top view of a left bottom frame fitting.

FIG. 18 is a front side view of a left bottom frame fitting.

FIG. 19 is a right side view of a left bottom frame fitting.

FIG. 20 is a top view of a right bottom frame fitting.

FIG. 21 is a front side view of a right bottom frame fitting.

FIG. 22 is a right side view of a right bottom frame fitting.

FIG. 23 is a top view of a tri-support rod joint fitting.

FIG. 24 is a side view of a tri-support rod joint fitting.

FIG. 25 is a top view of a base segment T-fitting.

FIG. 26 is a side view of a base segment T-fitting.

FIG. 27 is a side view of pyramid garden structure with cover in place.

FIG. 28 is a perspective view of a cover nose cone.

FIG. 29 is a front side view of a cover hanging rack.

FIG. 30 is a front perspective wire frame view of a planter.

FIG. 31 is a top view of an upper level soil container.

FIG. 32 is a left perspective view of assembled right center frame fitting.

FIG. 33 is a left perspective view of assembled right bottom frame fitting.

FIG. 34 is a left perspective view of assembled left center frame fitting.

FIG. 35 is a perspective view of assembled base segment T-fitting.

### DETAILED DESCRIPTION OF THE INVENTION

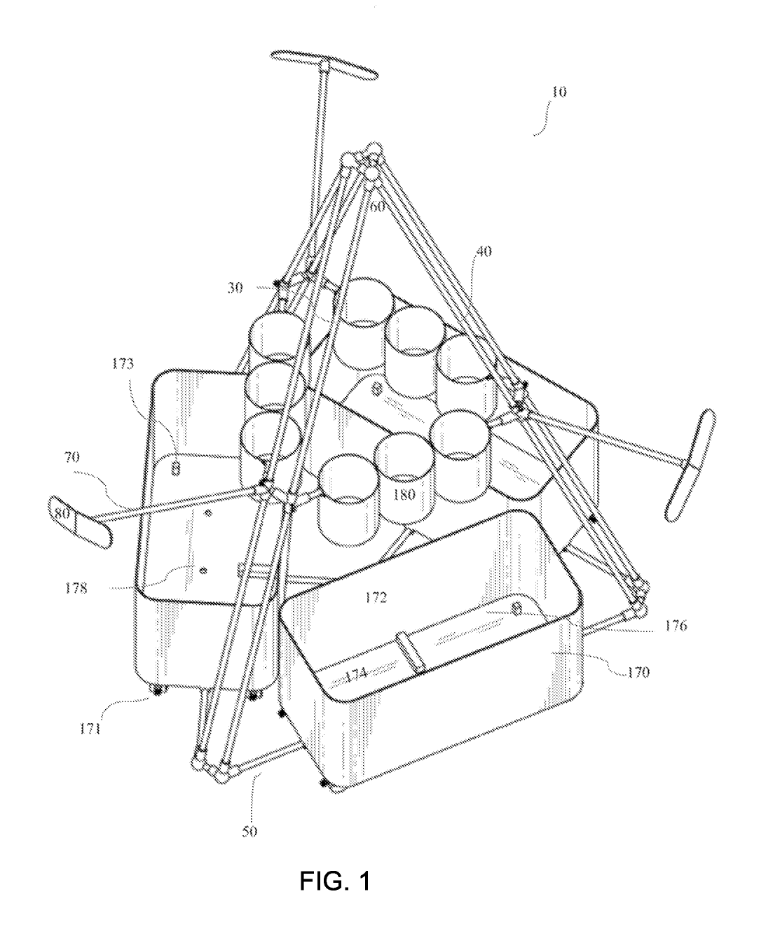

The basic unit of the plant growing apparatus is a trellis panel 10. A trellis panel 10 comprises a trellis panel frame 20 constructed from multiple rods, which may be hollow pipes, joined together by fittings. The trellis panel frame 20 preferably includes a simple geometric shape that bounds a defined interior area. In an exemplary embodiment as shown in FIG. 1 a trellis panel frame 20 may include a triangle having a left vertical segment 30 with a left lower end 32 and a left upper end 34, a right vertical segment 40 having a right lower end 42 and a right upper end 44, a base segment 50 attached between said left lower end 32 and right lower end 42, and an apex 60 where said left upper end 34 and right upper end 44 converge. As shown in FIG. 1 it is contemplated that a trellis panel frame 20 may also include a cover arm 70 that is attached at a near end 72 of said cover arm to the right vertical segment 40 and which extends away from said vertical segment at an upward acute angle θ and terminates at a distal end 74 with a cover arm cap 80. It is further contemplated that the trellis panel frame 20 of the preferred embodiment shown in FIG. 7 would include a tri-support rod 90 attached at a near end 92 to said base segment 50 and which extends away from said base segment 50 at a roughly perpendicular angle terminating at a distal end 94. The rods making up the trellis panel frame 20 may be made of any suitable material, but in the preferred embodiment are composed of polyethylene, which may be tinted any color.

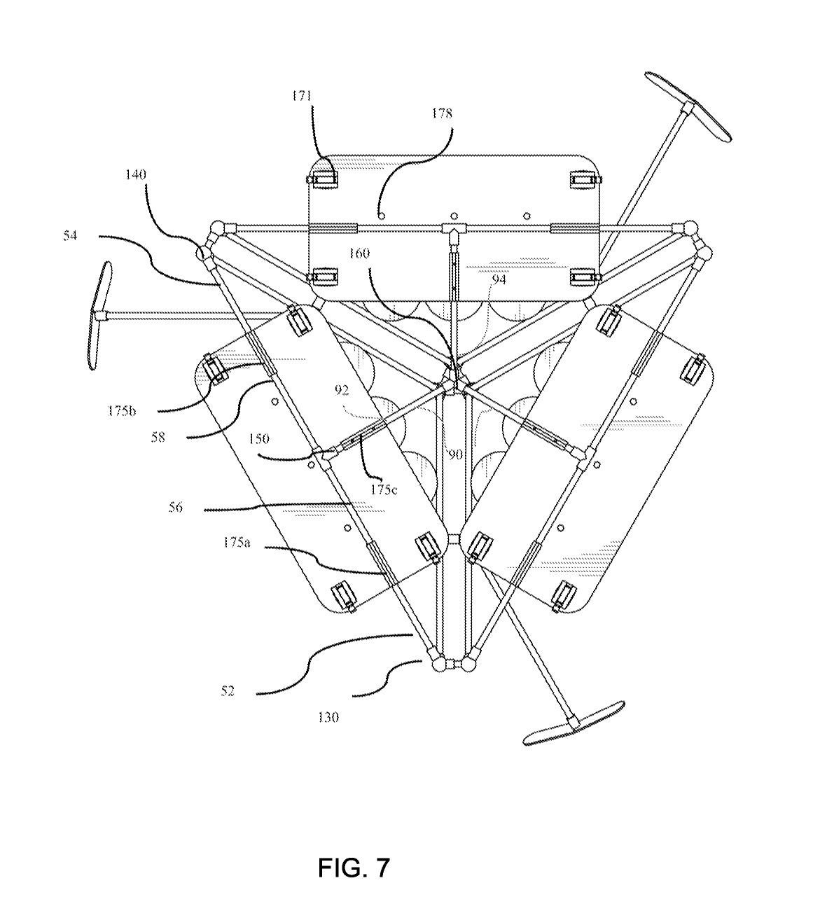

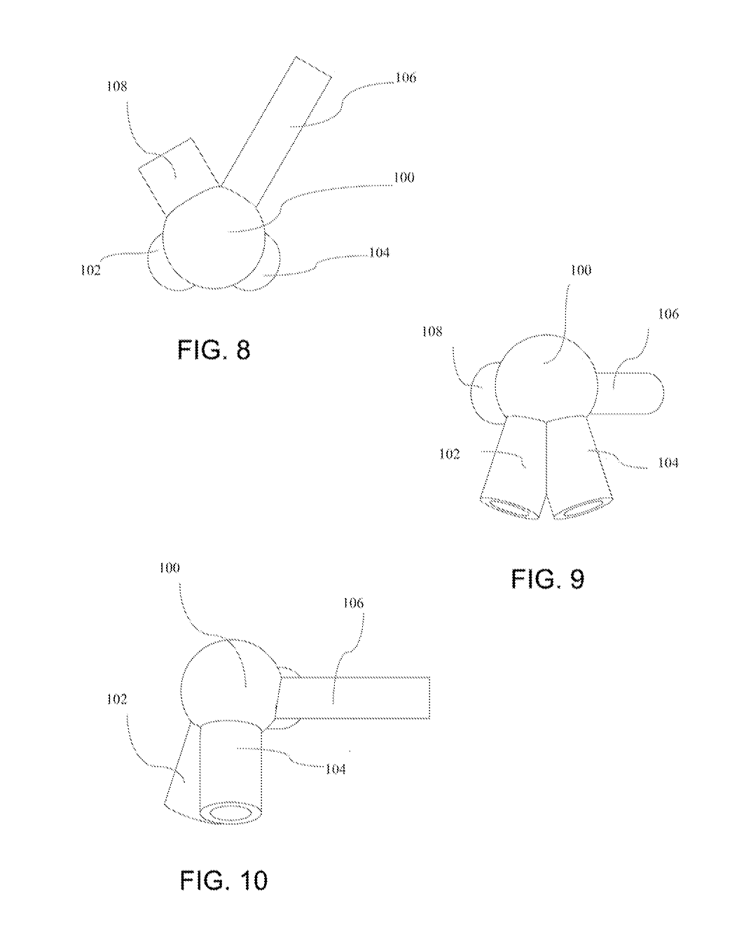

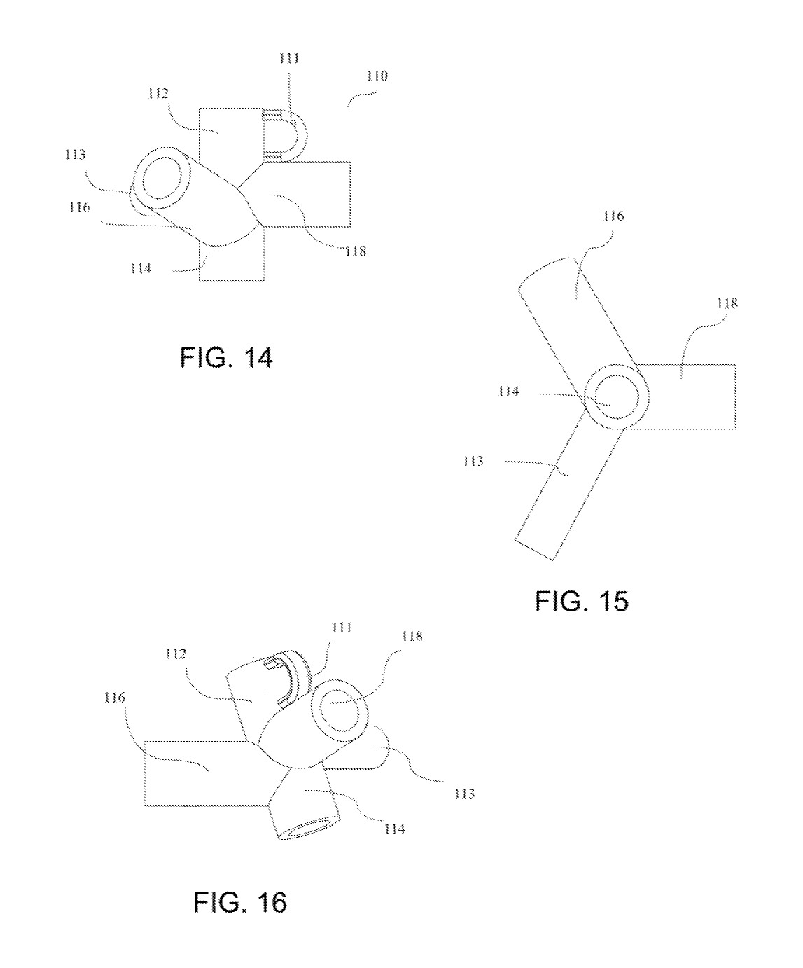

The fittings for joining together the rods that make up the trellis panel frame 20 used in the preferred embodiment are shown in FIGS. 8-26. A top frame fitting 100 used to connect vertical segments 30 and 40 of trellis panel frame 20 at their left upper end 34 and second upper end 44 is shown in FIGS. 8-10. Top frame fitting 100 has a left vertical socket 102 and right vertical socket 104 with for receiving and attaching upper ends 34 and 44 of vertical segments 30 and 40 of trellis frame 20. Top frame fitting 100 also has a right horizontal connector post 106 and a left horizontal socket 108 with an open end for receiving and attaching to a right horizontal connector post 106 of another top frame fitting 100 of an adjoining trellis panel frame 20.

A right center frame fitting 110 is shown in FIGS. 14-16. Right center frame fitting 110 has an upper socket 112 congruent with a lower socket 114 that connects a right upper segment rod 46 and right lower segment rod 48 to form right vertical segment 40. Right center frame fitting 110 also has a left socket 116 for receiving an upper level soil container right support rod 183 for attaching upper level soil container 180 to right vertical segment 40. Right center frame fitting 110 also has a cover arm socket 118 used to attach cover arm 70 to right vertical segment 40. A right joining post 113 of right center frame fitting 110 is used to attach right center frame fitting 110 to a left center frame fitting 120 when attaching an adjoining trellis frame 20. Right center frame fitting also has a dimension loop 111.

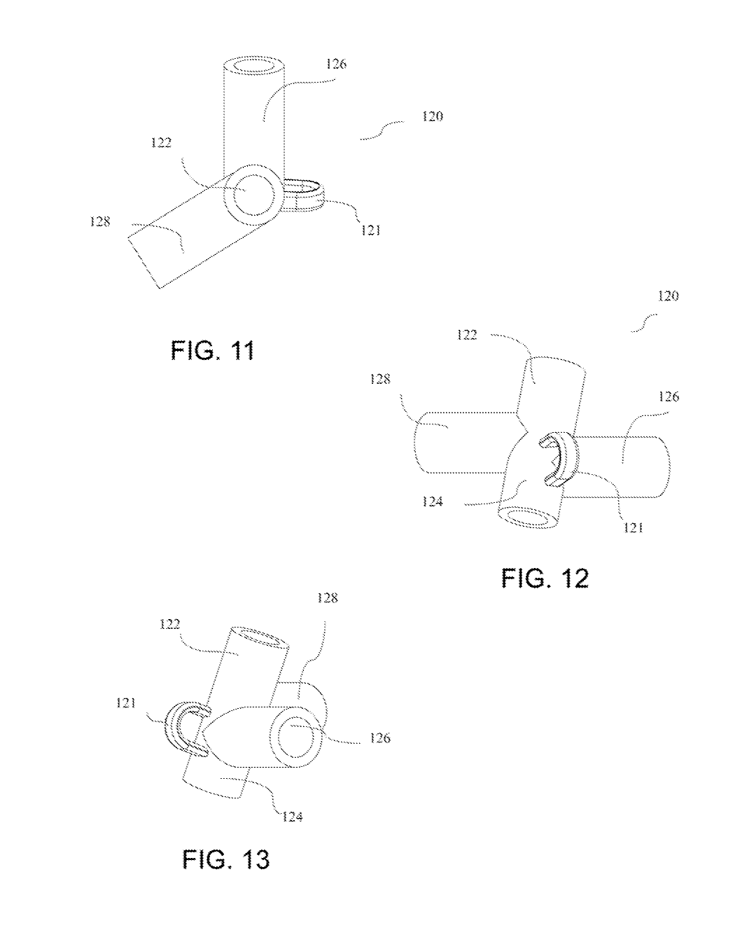

A left center frame fitting 120 is shown in FIGS. 11-13. Left center frame fitting 120 has an upper socket 122 congruent with a lower socket 124 that connects a left upper segment rod 36 and left lower segment rod 38 to form left vertical segment 30. Left center frame fitting 120 also has a right side socket 126 for receiving an upper level soil container left support rod 181 for attaching upper level soil container 180 to left vertical segment 30. Left center frame fitting 120 has a left side socket 128 for receiving a right joining post 113 of a right center frame fitting 110 when attaching an adjoining trellis frame 20. Left center frame 120 fitting also has a dimension loop 121.

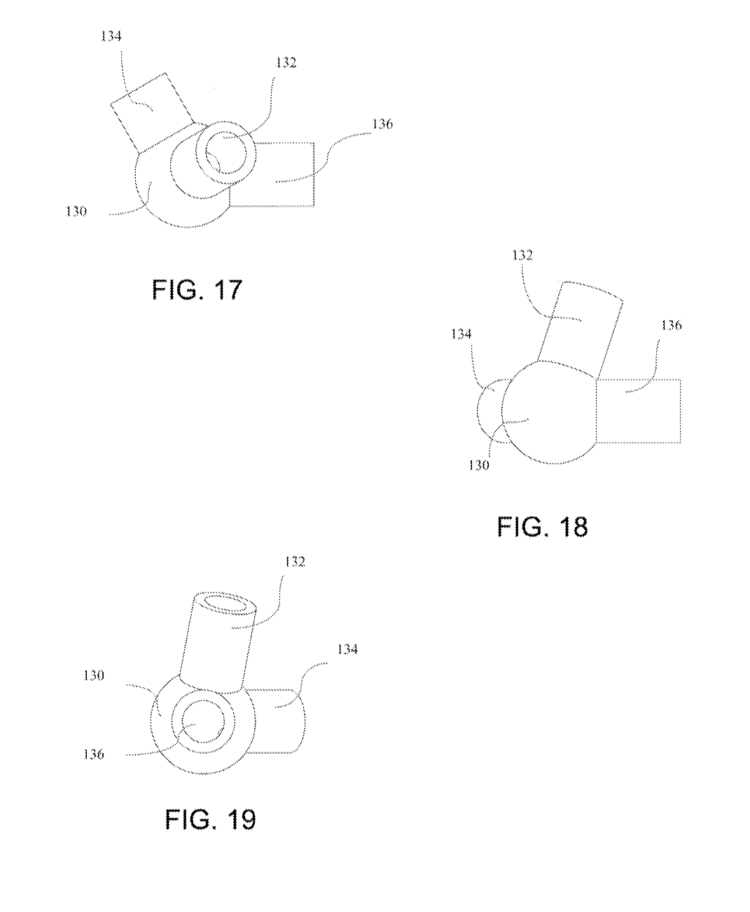

A left bottom frame fitting 130 is shown in FIGS. 17-19. Left bottom frame fitting 130 has an upper socket 132 for attaching to the lower end 32 of left vertical segment 30, and a left side socket 134 used to connect to a right bottom frame fitting post 146, and a right side socket 136 for connecting to the left end 52 of a base segment 50.

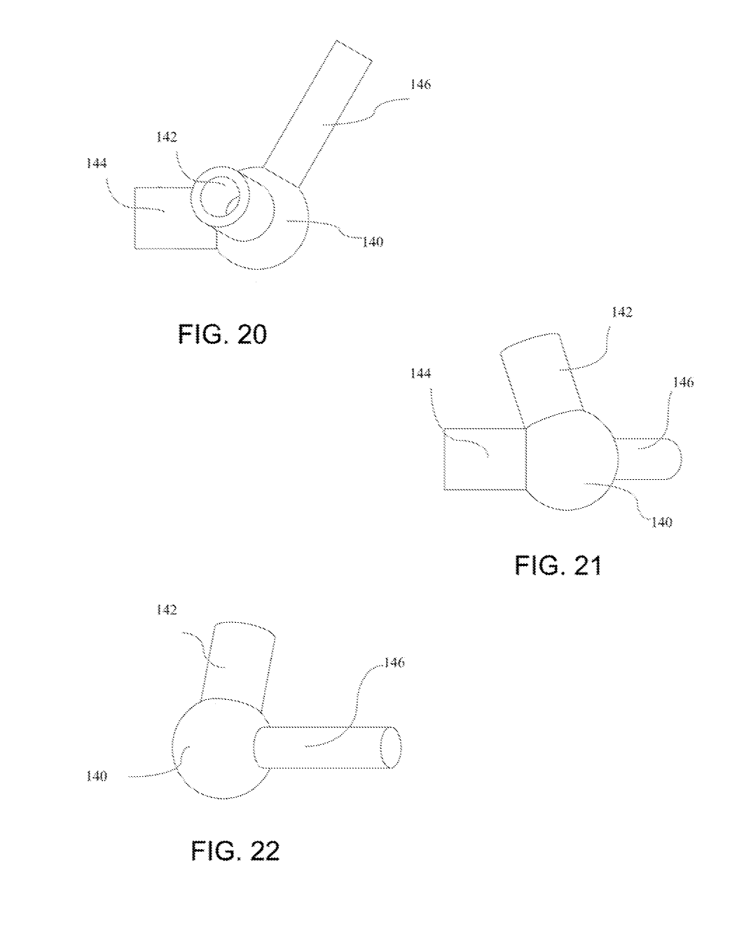

A right bottom frame fitting 140 is shown in FIGS. 20-22. Right bottom frame 140 fitting has an upper socket 142 for attaching to the lower end 42 of right vertical segment 40, and a left side socket 144 used to connect to a right end 54 of a base segment 50, and a right side fitting post 146 for connecting to the left side socket 134 of a left bottom frame fitting 130 when attaching an adjoining trellis frame 20.

Base segment T-fitting 150 is shown in FIGS. 25-26. T-fitting 150 has a left side socket 152 congruent with a right side socket 154 that connects a left base segment rod 56 and right base segment rod 58 together to form base segment 50. The T-fitting 150 also has a tri-support rod socket 156 extending away from and perpendicular to said base segment 50 for attaching to a near end 92 of a tri-support rod 90.

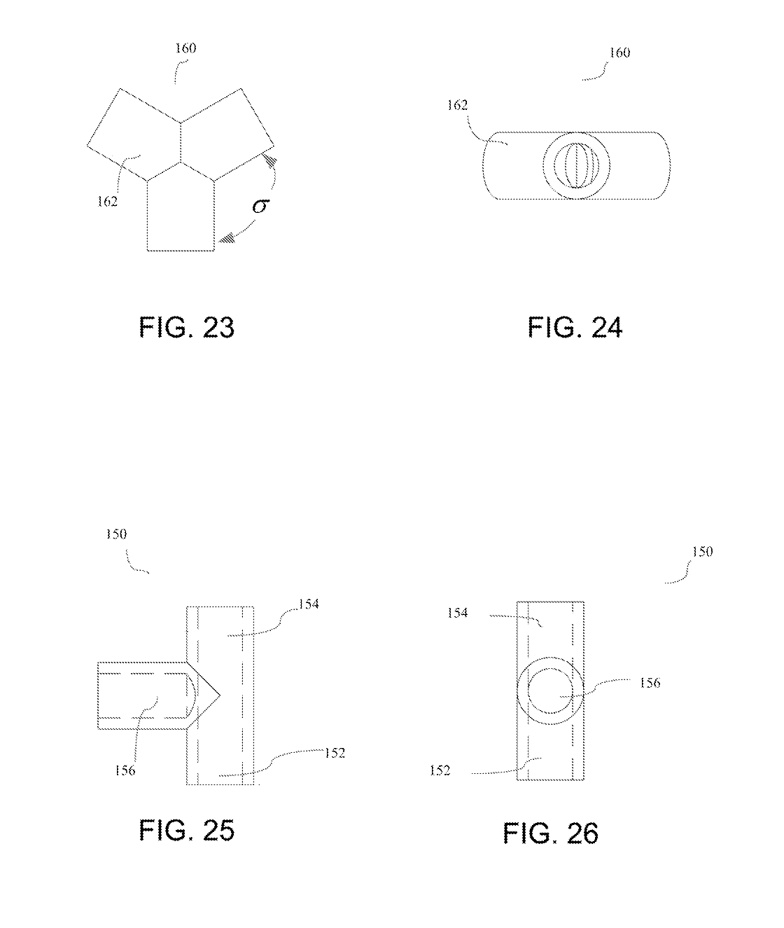

A tri-support rod joint fitting 160 is shown in FIGS. 23-24. The tri-support rod joint fitting 160 of the preferred embodiment has three co-planar horizontal support rod sockets 162 for attaching to the distal ends 94 of tri-support rods 90 and joining them together when attaching adjoining trellis panel frames 20. Preferably the three horizontal support rod sockets 162 are separated from one another by equal angles σ of 120 degrees.

The fittings described herein and illustrated in FIGS. 8-26 are contemplated to be made of polyethylene, and may be color tinted. It is contemplated that the frame fittings connect with rods or other frame fittings by means of a press fit or adhesive fit.

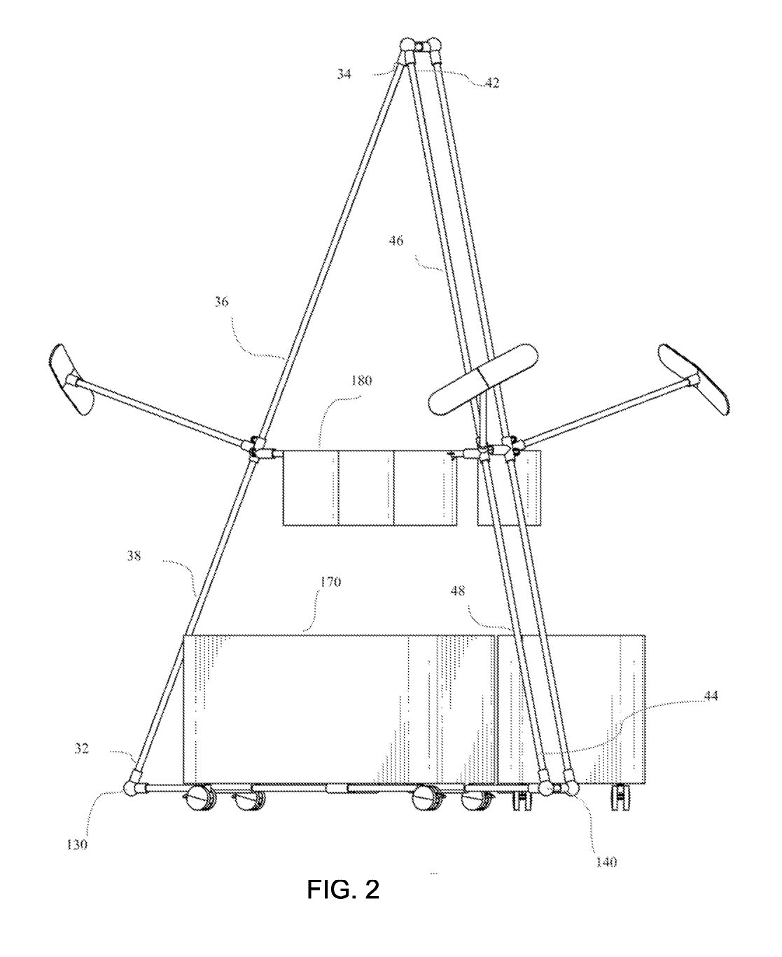

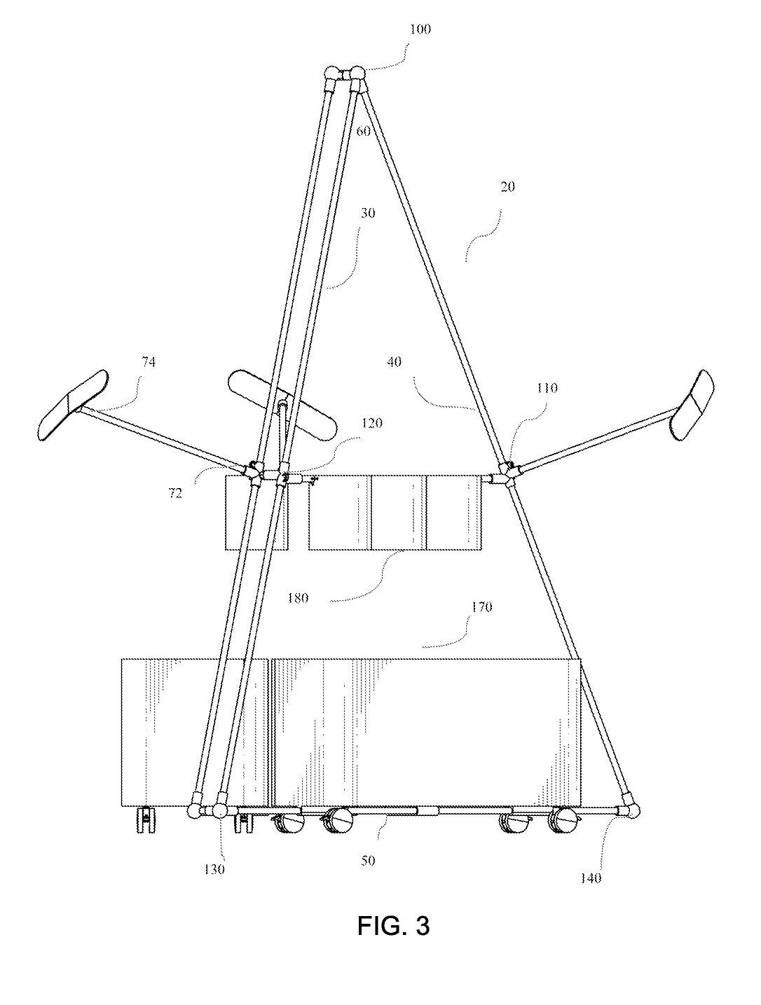

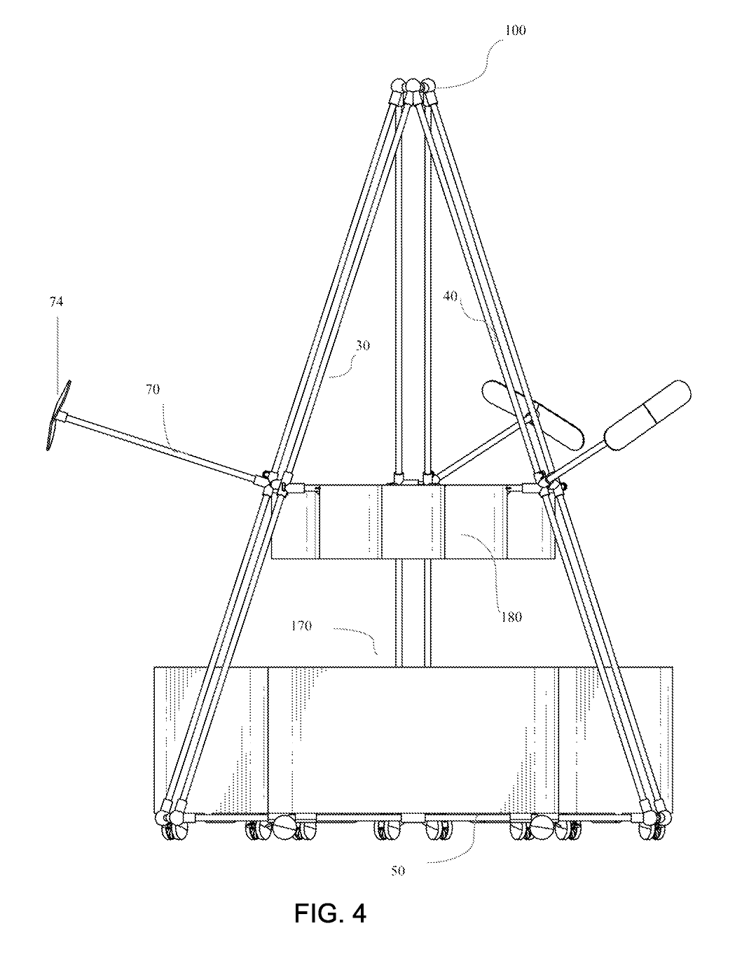

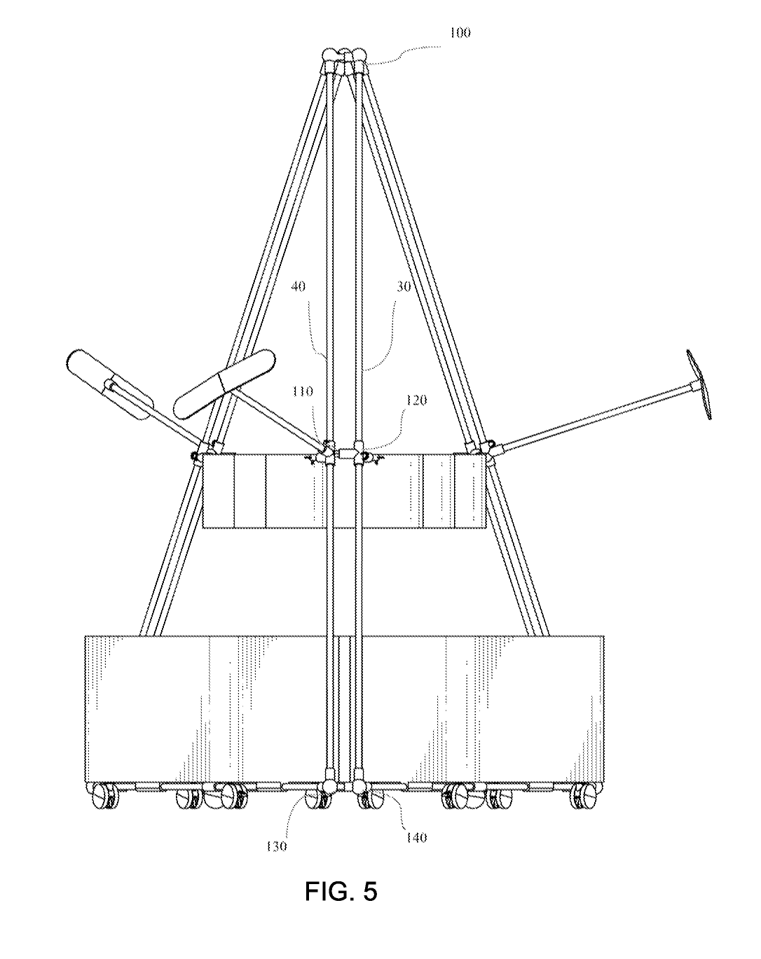

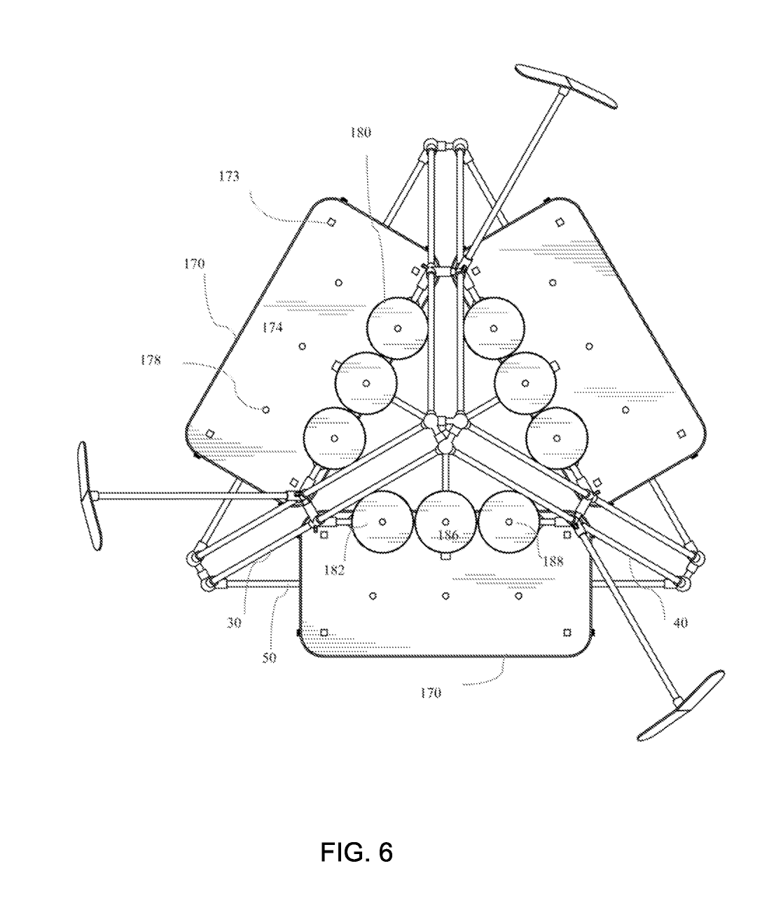

Attached to the base segment 50 of each trellis panel frame 20 is a planter 170. In the preferred embodiment planter 170 is a rectangular box with four vertical walls 172, a floor 174, and a top opening 176. It is contemplated that planter 170 may come in different sizes, such as for example, 12 inches (d)×12 inches (h)×12 inches (w), or 12 inches (d)×12 inches (h)×24 inches (w). Planter 170 has at least one drainage hole 178 in floor 174 to allow for drainage. Planter 170 may also have wheels or casters 171 attached to the underside of the floor 174, such as for example by way of recesses 173 molded into the floor of planter 170. Planter 170 is attached to the base segment 50 of the trellis panel frame 20 by at least one planter fastener. In the preferred embodiment shown in FIGS. 1-7 a planter fastener is a hollow tube structure molded into the underside of the planter floor 174. There is a left side planter fastener 175a on a left side of planter floor 174 that is congruent with a right side planter fastener 175b on the right side of planter floor 174. Base segment 50 passes through left side planter fastener 175a and right side planter fastener 175b. There is also a third tri-support rod planter fastener 175c through which the tri-support rod 90 passes.

Attached to trellis panel frame 20 between left vertical segment 30 and right vertical segment 40, and above planter 170, is an upper level soil container 180. In a preferred embodiment upper level soil container 180 has three recessed pot openings 182 each having a roughly cylindrical inner wall 184 and circular floor 186. In such a preferred embodiment it is contemplated that each recessed pot opening 182 may be five inches in diameter. It is also contemplated for a smaller pyramid garden system that the upper level soil container 180 would just have one recessed pot opening 182 of five inches diameter. Preferably there is at least one drainage opening 188 in the floor 186 of each recessed pot opening. Drainage from upper level soil container 180 will exit said at least one drainage opening 188 and fall into planter 170 below. Upper level soil container 180 is attached to left vertical segment 30 by left support rod 181 joining with right side socket 126 of left center frame fitting 120, and is attached to right vertical segment 40 by right support rod 183 joining with left side socket 116 of right center frame fitting 110. Support rod 181 and support 183 are preferably molded extrusions on upper level soil container 180.

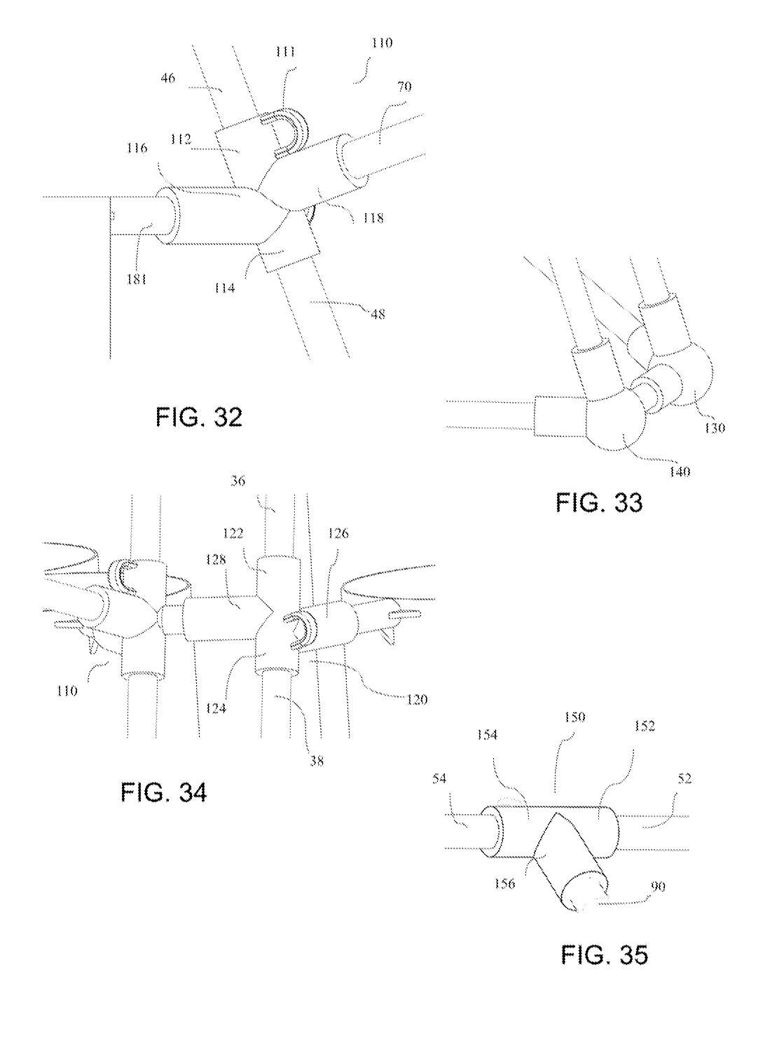

The pyramid garden system of the present invention is constructed by connecting together one or more trellis panel frames 20. In the preferred embodiment three triangular shaped trellis panel frames 20 as described and illustrated herein are combined into a pyramid shaped garden system. Specifically, the apexes 60 of the three triangular trellis panel frames 20 are joined together by their three respective top frame fittings 100 being joined together by inserting the right horizontal connector post 106 of each trellis panel frame 20 into the left horizontal socket 108 of top frame fitting 100 for an adjoining trellis panel frame 20. See e.g. FIG. 1. Each right vertical segment 40 is attached to the left vertical segment 30 of an adjoining trellis panel frame 20 by connecting left center frame fitting 120 on the left vertical segment 30 with right center frame fitting 110 on the right vertical segment 40 by inserting right joining post 113 into left side socket 128, and also inserting the right side fitting post 146 of right bottom frame fitting 140 into left side socket 134 of left bottom frame fitting 130. FIGS. 32-34. The tri-support rod 90 of each trellis panel frame 20 is joined to the tri-support rod 90 of the other adjoining trellis panel frames 20 by insertion of distal end 94 of each tri-support rod 90 into horizontal support rod sockets 162 of the tri-support rod joint fitting 160. See FIGS. 7 & 35.

The pyramid garden system of the preferred embodiment is also contemplated to have an efficient irrigation drip system incorporated into it. The contemplated irrigation drip system is a polyethylene irrigation pipe with a first end and a second end, as well as one or more dripping outlets along the irrigation pipe. The irrigation pipe is contemplated to be connected to trellis panel frames and follow a circular path within the pyramid garden with the first and second ends being connected together at a three opening hollow t-fitting, with the third opening being connected to one end of a pipe or hose that to has its other end attached to a check valve. A garden hose may be connected to the check valve. When the hose is connected to a pressurized water supply it will force water through the check valve and fill the irrigation pipe with water under pressure. The water under pressure will exit the irrigation pipe through the drip system. Water exiting the irrigation pipe through the drip system will enter the upper level soil containers and the planters of the pyramid garden system.

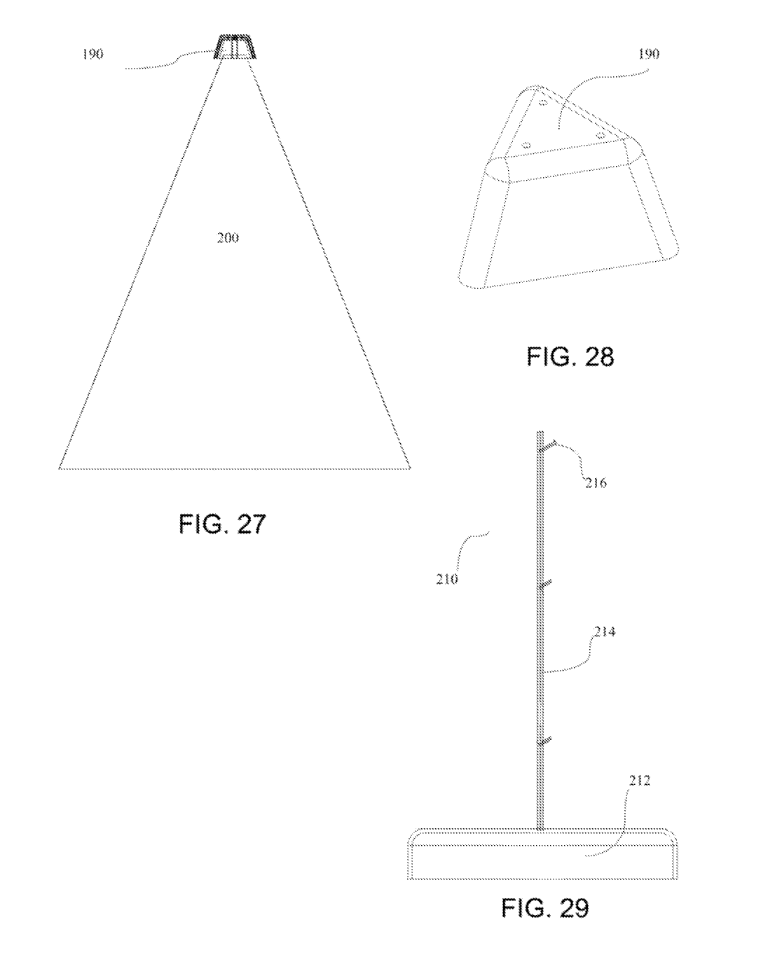

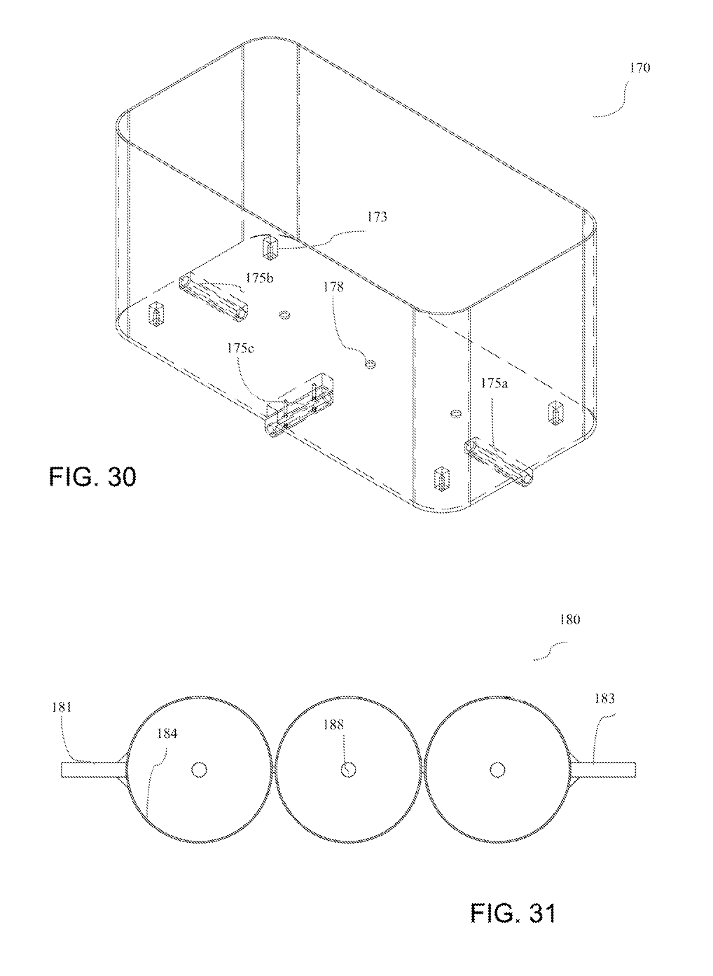

The pyramid garden system of the preferred embodiment is also contemplated to have a cover 200 roughly in the shape of a triangle which fits over the pyramid garden structure 10 like a teepee. See FIG. 27. The cover 200 is cut into a triangular shape with an apex, two vertical edges and a base edge such that it can be wrapped around the pyramid garden structure 10, supported by the cover arms 70. Apex portion of the cover 200 may be secured to the apex of the pyramid garden structure 10 by a nose cone 190 that fits over the apex of the pyramid garden structure 10. See FIG. 28. The nose cone 190 may be formed by two overlapping halves that join together by a lower male half being inserted into an upper female half. The apex portion of the cover 200 may be attached to the lower male half and then securely clamped between the two nose cone halves for placement on the apex of the pyramid garden structure 10. The base edge of cover 200 may contain one or more pockets or flaps for containing weights to help provide tension to the cover 200 over the pyramid garden structure 10 and keep the cover in place. It is contemplated that the weights may be in the shape of rods and made of polyethylene. The weights may be inserted or removed from the bottom pocket or flap. Alternatively there may be separate ring weight of suitable diameter to place over the base of pyramid garden structure 10 and on top of the base edge of cover 200. The vertical edges of the cover 200 are preferably joined together by means of Velcro strips such that the cover 200 may be opened or closed to provide access to the pyramid garden structure and plants. The cover 200 may be made of cloth for providing shade, and protecting the garden plants from birds or insects. The cover 200 may also be made from an appropriate plastic so as to function as a greenhouse for the plants in the garden structure.

The cover 200, when used, is intended to be opened periodically by the user of the pyramid garden system to facilitate the entry of fresh air to the interior of the pyramid garden structure and plants, as well as access to the plants by the user. When opening the cover 200 it is contemplated that the open sides of the cover 200 may be placed by the user on one or more separate cover hanging racks 210 adjacent to the pyramid garden system, such that the cover 200 will remain open while the user's hands are free and accessing the plants or the pyramid garden structure. Such a cover hanging rack 210 may be in the form of a round weighted base 212 with a vertical pole 214 extending upwards with one or more extending arms 216 for supporting or hanging cover 200 on: Similar to a coat rack in structure, but sized for use with the pyramid garden system and its cover. See FIG. 29.

It is further contemplated that a shallow dish or mat may be placed under the pyramid garden structure to collect any excess water and prevent it from collecting on the surface under the pyramid garden system.

In use it is contemplated that the planters and pot structures of the modular garden system will use a potting soil. In a preferred embodiment the potting soil consists of a well mixed 1 quarter vermiculate, 1 quarter mushroom compost, 1 quarter soil, and 1 quarter coffee beans (preferably grinds). The aforementioned coffee beans may be recycled from personal or commercial coffee beverage making operations.

1. An apparatus for growing plants comprising
a garden structure having a plurality of connected trellis panel frames;
each of said trellis panel frames having a plurality of frame segments;
each of said frame segments having at least one end;
said plurality of frame segments connected together at said ends so as to bound an interior area between said frame segments; and
for each of said trellis panel frames a planter within said interior space connected to a frame segment.

2. The apparatus for growing plants of claim 1 wherein each trellis panel frame of said garden structure is connected to an adjoining trellis panel frame through a fitting.

3. The apparatus for growing plants of claim 1 wherein each end of a frame segment is connected through a fitting to an end of another frame segment.

4. The apparatus for growing plants of claim 1 wherein each frame segment is hollow.

5. The apparatus for growing plants of claim 1 wherein said planter has a floor with a drainage hole in said floor.

6. The apparatus for growing plants of claim 1 further comprising a plurality of said planters arranged vertically within said interior space.

7. The apparatus for growing plants of claim 1 further comprising an irrigation pipe attached to said garden structure.

8. The apparatus for growing plants of claim 1 further comprising a cover attached to said garden structure;

9. The apparatus for growing plants of claim 8 further comprising a cover arm attached to a frame segment of each trellis panel frame.

10. An apparatus for growing plants comprising
a pyramid shaped garden structure having three connected triangular trellis panel frames;
each of said triangular trellis panel frames having a horizontal base frame segment connected at a left end to a lower left end of a left vertical frame segment, said horizontal base frame segment connected at a right end to a lower right end of a right vertical frame segment, said left vertical frame segment having an upper left end connected to an upper right end of said right vertical frame segment, such that said horizontal base frame segment, said left vertical frame segment, and said right vertical frame segment bound a triangular interior space; and
at least one planter within said interior space connected to at least one of said frame segments.

11. The apparatus for growing plants of claim 10 wherein each trellis panel frame of said garden structure is connected to an adjoining trellis panel frame through a fitting.

12. The apparatus for growing plants of claim 10 wherein each end of a frame segment is connected through a fitting to an end of another frame segment.

13. The apparatus for growing plants of claim 10 wherein each frame segment is hollow.

14. The apparatus for growing plants of claim 10 wherein said planter has a floor with a drainage hole in said floor.

15. The apparatus for growing plants of claim 10 further comprising a plurality of said planters arranged vertically within said interior space.

16. The apparatus for growing plants of claim 10 further comprising an irrigation pipe attached to said garden structure.

17. The apparatus for growing plants of claim 10 further comprising a cover attached to said garden structure.

18. The apparatus for growing plants of claim 17 further comprising a cover arm attached to a frame segment of each trellis panel frame.

19. A kit for a system to grow plants comprising
a plurality of frame segments;
a plurality of fittings used to connect said frame segments into a plurality of trellis panel frames and to interconnect said trellis panel frames;
a planter; and
a means to connect said planter to a frame segment.

20. The kit for a system to grow plants of claim 19 further comprising potting soil.

21. The kit for a system to grow plants of claim 20 wherein said potting soil comprises a mixture of vermiculate, mushroom compost, soil, and coffee beans.

22. The kit for a system to grow plants of claim 19 further comprising a cover.
